(19) United States
(12) Patent Application Publication
(10) Pub. No.: US 2025/0235383 A1
(43) Pub. Date: Jul. 24, 2025

(54) MEDICINE REFRIGERATION CUP WITH PORTABLE MEDICINE BOX

(71) Applicant: Zhejiang Sunclose Technology CO., LTD., Jinhua (CN)

(72) Inventors: HUAJIAN ZHANG, Jinhua (CN); JINGPING LI, Jinhua (CN)

(21) Appl. No.: 19/001,479

(22) Filed: Dec. 25, 2024

Related U.S. Application Data
(63) Continuation of application No. PCT/CN2024/075254, filed on Feb. 1, 2024.

(30) Foreign Application Priority Data
Jan. 24, 2024 (CN) 202420169527.6

(51) Int. Cl. A61J 1/16; A61J 1/14

(52) U.S. Cl. CPC A61J 1/165; A61J 1/1418; A61J 2200/44

(57) ABSTRACT

A medicine refrigeration cup with a portable medicine box is provided, which includes a cup body, a refrigeration device, a hanging ring, and a medicine box. The cup body includes a cup main body and a cup cover, the refrigeration device is provided in the cup cover, the hanging ring includes a ring-shaped member sleeved on the cup main body and a first hanging groove protruding from one side of the ring-shaped member. The first hanging groove includes a first outer groove wall. The medicine box includes a second medicine compartment, and an end portion provided at one axial end of the second medicine compartment. The end portion includes a second hanging groove. The second hanging groove includes an open end, a closed end, and a second outer groove wall. The second outer groove wall is inserted into the first hanging groove.

### CROSS-REFERENCE TO RELATED APPLICATIONS

This application is a continuation of International Application No. PCT/CN2024/075254, filed on Feb. 1, 2024, entitled “MEDICINE REFRIGERATION CUP WITH PORTABLE MEDICINE BOX”, which claims priority of Chinese Patent Application No. 202420169527.6, filed on Jan. 24, 2024 in the China National Intellectual Property Administration (CNIPA), the entire contents of which is hereby incorporated by reference in its entireties.

### TECHNICAL FIELD

The present disclosure relates to the field of medicine technologies, and in particular, to a medicine refrigeration cup with a portable medicine box.

### BACKGROUND

Chinese patent with application number of CN202320137746.1 filed on Feb. 7, 2023 discloses a medicine refrigeration cup, which includes a cup body and a cup cover. The cup cover is equipped with an electrically driven refrigeration component, which maintains a low temperature in the cup body when powered on; a lower part of the refrigeration component is connected to a hollow cylindrical cooling pipe, and an upper end of the cooling pipe is fixedly connected to the refrigeration component. The lower end of the cooling pipe is extended into the cup body, and the cup body is equipped with a detachable insulation cup sleeve.

In daily life, a patient often needs to take multiple types of medications at the same time, fewer types of medicine require refrigeration storage. One way is to use another container to store medicine that can be stored at room temperature, which can easily lead to missed doses or reduce consistency in medication time, affecting treatment effectiveness. Another way is to store all medicine in a refrigerated cup, which has the following limitations: occupying the medicine space that needs to be refrigerated, actually reducing the capacity of the refrigeration cup; requiring multiple opening and closing of the refrigeration cup to increase energy consumption, which is not conducive to maintaining the consistency of the low-temperature environment inside the cup; a lack of partitions in the cup, which is not convenient for taking medicine.

### SUMMARY

The purpose of the present disclosure is to provide a medicine refrigeration cup with a portable medicine box to meet needs of a user, in response to the shortcomings of the existing technology mentioned above.

To achieve the above objectives, the present disclosure provides a drug refrigeration cup with a portable medicine box, including:
a cup body including a cup main body with a first medicine compartment and a cup cover configured to close the first medicine compartment,
a medicine box detachably suspended from the cup main body or the cup cover,
where the cup body or the cup cover includes a first disassembly-and-assembly part, the medicine box includes a second medicine compartment and an end portion provided at one axial end of the second medicine compartment; the medicine box includes a second disassembly-and-assembly part; a suspension of the medicine box is achieved by a plug-in fit, a snap fit, a thread fit, a magnetic suction fit, a snap fit, a clamp groove fit or a slide fit of the first disassembly-and-assembly part and the second disassembly-and-assembly part; or
the cup main body or the cup cover is connected to a mesh pocket part, and the medicine box is accommodated in the mesh pocket part to achieve the suspension of the medicine box.

In some embodiments of the present disclosure, the first disassembly-and-assembly part includes a first hanging groove, and the first hanging groove includes a first outer groove wall; the second disassembly-and-assembly part includes a second hanging groove, and the second hanging groove includes an open end, a closed end, and a second outer groove wall; the second outer groove wall is inserted into the first hanging groove, and the first outer groove wall is configured to inserted into the second hanging groove through the open end and abut against the closed end; the first hanging groove is configured to support the medicine box in a gravity direction, so that the medicine box is detachably suspended on the cup body.

In some embodiments of the present disclosure, the first disassembly-and-assembly part includes a fastening groove, the second disassembly-and-assembly part includes a limit buckle protruding from the end portion; the fastening groove includes a limit groove wall with a buttonhole, the limit buckle is extended into the fastening groove through the buttonhole, and the limit buckle abuts against the limit groove wall to limit a separation between the two.

In some embodiments of the present disclosure, the first hanging groove is arranged along the gravity direction, and the open end is located at a lower end of the second hanging groove; an upper end of the first outer groove wall is configured to support the closed end along the gravity direction, or the open end is located at an upper end of the second hanging groove; one end of the second outer groove wall forms the open end, and is internally fastened to form a stop tongue; an upper end of the first outer groove wall is configured to support the stop tongue along the gravity direction.

In some embodiments of the present disclosure, the first hanging groove is arranged along a tangent direction of the cup body, and the first hanging groove is configured to support the second outer groove wall along the gravity direction.

In some embodiments of the present disclosure, the end portion includes an inlet chamber configured to communicate with the open end, where a limit tongue configured to cover a portion of the open end is provided in the inlet chamber; the first outer groove wall is configured to translate into the inlet chamber, and the first outer groove wall is configured to overcome a resistance provided by the limit tongue to enter and exit the second hanging groove.

In some embodiments of the present disclosure, the limit tongue includes a first limit inclined surface, a guide surface, and a second limit inclined surface, the first outer groove wall is configured to overcome a resistance provided by the first limit inclined surface to enter the second hanging groove, and the second groove wall is configured to overcome a resistance provided by the second limit inclined surface to exit the second hanging groove; the guide surface is arranged in a vertical direction and is configured to slide and cooperate with the first outer groove wall.

In some embodiments of the present disclosure, the end portion includes a first end shell and a second end shell that are spliced together; the first end shell includes the second outer groove wall and the limit tongue, the second end shell includes a second inner groove wall configured to cooperate with the second outer groove wall to form the second hanging groove, and a space configured to allow the limit tongue to deform under pressure.

In some embodiments of the present disclosure, the second outer groove wall includes a plurality of limit protrusions, and the limit protrusions cooperate with the second inner groove wall to clamp the first outer groove wall, or the second inner groove wall includes a plurality of limit protrusions, and the limit protrusions cooperate with the second outer groove wall to clamp the first outer groove wall.

In some embodiments of the present disclosure, the medicine refrigeration cup further includes a hanging ring, where the hanging ring includes a ring-shaped member sleeved on the cup main body and the second disassembly-and-assembly part protruding from one side of the ring-shaped member.

In some embodiments of the present disclosure, an embedded area configured to install the hanging ring is formed at one end of the cup main body close to the cup cover, where the embedded area includes a circumferential step configured to support the ring-shaped member; the cup cover cooperates with the circumferential step to form an axial limit on the ring-shaped member.

In some embodiments of the present disclosure, the embedded area further includes a fitting circumferential wall that is closely adhered to the ring-shaped member, the fitting circumferential wall is radially inwardly concave to form an annular positioning groove, and a middle area of an inner circumferential wall of the ring-shaped member is provided with a positioning rib configured to be clamped into the positioning groove.

In some embodiments of the present disclosure, the hanging ring includes the ring-shaped member sleeved on the cup main body and the mesh pocket part protruding from one side of the ring-shaped member; a depth of the mesh pocket part exceeds one-third of a length of the medicine box.

In some embodiments of the present disclosure, the cup cover is provided with a handle that is capable of being held, and/or an outer circumferential surface of the ring-shaped member is provided with a plurality of third hanging grooves configured to install an annular lift rope, where the third hanging grooves include an installation port configured for the annular lift rope to be clamped into.

In some embodiments of the present disclosure, the medicine box further includes a cover plate configured to seal the second medicine compartment, one side of the cover plate is hinged to the second medicine compartment, and the other side of the cover plate is engaged with the second medicine compartment by interlocking or magnetic adsorption.

In some embodiments of the present disclosure, the medicine box further includes an outer housing configured to enclose the second medicine compartment, the outer housing includes a cavity with a cavity opening, the second medicine compartment enters the cavity through the cavity opening, and when the second medicine compartment is completely accommodated in the cavity, the cavity opening is engaged with the second medicine compartment by interlocking or magnetic adsorption.

The cover plate or the outer housing is designed to ensure a drying effect in the second medicine compartment, thereby avoiding an occurrence of moisture in the medicine stored in the medicine box.

In some embodiments of the present disclosure, one side of the second end shell facing away from the first end shell forms a unit medicine compartment configured to form a part of the second medicine compartment, and the cover plate is configured to seal the unit medicine compartment.

In some embodiments of the present disclosure, an outer surface of the end portion is arranged flush with an outer surface of the outer housing; one axial end of the second medicine compartment shares a first stop end face with the end portion, and the other axial end of the second medicine compartment is provided with a second stop end face; the two axial ends of the outer housing are configured to respectively abut against the first stop end face and the second stop end face.

In some embodiments of the present disclosure, the refrigeration device includes a semiconductor refrigeration chip with a cold end face and a hot end face, a cold conduction tube configured to connect the cold end face, a heat conduction member configured to connect the hot end face, and a heat dissipation fan provided above the heat conduction member; the in cold conduction tube is configured to be extended into the first medicine compartment.

The beneficial effects of the present disclosure are as follows.

By providing the hanging ring, the medicine box can be detachably suspended from the cup body, and medicine stored at room temperature can be placed in the medicine box, which can improve a consistency of a patient taking medication on time and in a prescribed amount. At the same time, it can reduce frequent opening and closing of the cup body, which is conducive to maintaining a stable low-temperature environment in the first medicine compartment, reducing energy loss, prolonging the use time, and reducing the charging frequency.

### BRIEF DESCRIPTION OF DRAWINGS

FIG. 1 is a schematic structural diagram of a medicine refrigeration cup with a portable medicine box in an embodiment.

FIG. 2 is a schematic sectional view of the medicine refrigeration cup with a portable medicine box in an embodiment.

FIG. 3 is an enlarged schematic diagram of a part of FIG. 2.

FIG. 4 is an explosion schematic diagram of a medicine box in an embodiment.

FIG. 5 is an explosion schematic diagram in an embodiment of the present disclosure.

FIG. 6 is an explosion schematic diagram of the medicine box in an embodiment.

FIG. 7 is a schematic structural diagram of a cup cover in an embodiment of the present disclosure.

FIG. 8 is a schematic structural diagram of a cup body in an embodiment of the present disclosure.

FIG. 9 is a schematic cross-sectional view of the medication box in an embodiment.

FIG. 10 is a schematic sectional view of a hanging ring and the medicine box in an embodiment.

FIG. 11 is a schematic sectional view of the hanging ring and medicine box in an embodiment of the present disclosure.

FIG. 12 is a schematic sectional view of the hanging ring and medicine box in an embodiment of the present disclosure.

FIG. 13 is a schematic structural diagram of the hanging ring in an embodiment.

FIG. 14 is a schematic structural diagram of the hanging ring and the medicine box in an embodiment.

FIG. 15 is a schematic structural diagram of the hanging ring and the medicine box in an embodiment.

Numeral reference: cup main body 101, cup cover 102, first medicine compartment 103, handle 104, semiconductor refrigeration chip 105, cold conduction tube 106, heat conduction member 107, heat dissipation fan 108, hanging ring 109, ring-shaped member 110, first hanging groove 111, circumferential step 112, fitting circumferential wall 113, positioning groove 114, positioning rib 115, first outer groove wall 116, annular lift rope 117, third hanging groove 118, fastening groove 119, limit groove wall 120, buttonhole 121, first magnetic suction member 122, mesh pocket part 123, internal thread structure 124, clamp wall 125, installation column 126, sliding seat 127, sliding groove 128, medicine box 200, second medicine compartment 201, end portion 202, second hanging groove 203, second outer groove wall 204, second inner groove wall 205, first end shell 206, second end shell 207, inlet chamber 208, limit protrusion 209, limit tongue 210, cover plate 211, first stop end face 212, second stop end face 213, outer housing 214, first limit inclined surface 215, guide surface 216, second limit inclined surface 217, stop tongue 218, limit buckle 219, second magnetic suction member 220, external threaded structure 221, installation groove 222, slide rail 223, stop rail 224.

### DESCRIPTION OF EMBODIMENTS

In order to clarify the purpose, technical solution, and advantages of the present disclosure, a detailed description of the present disclosure will be provided below in combination with the accompanying drawings and specific embodiments.

Here, it should be noted that in order to avoid blurring the present disclosure due to unnecessary details, only the structures and/or processing steps closely related to the solution of the present disclosure are shown in the accompanying drawings, and other details that are not closely related to the present disclosure are omitted.

Besides that, it should be noted that terms “including”, “comprising”, or any other variation thereof are intended to encompass non-exclusive inclusion, such that a process, method, item, or device that includes a series of elements not only includes those elements, but also includes other elements that are not explicitly listed or are inherent to such a process, method, item, or device.

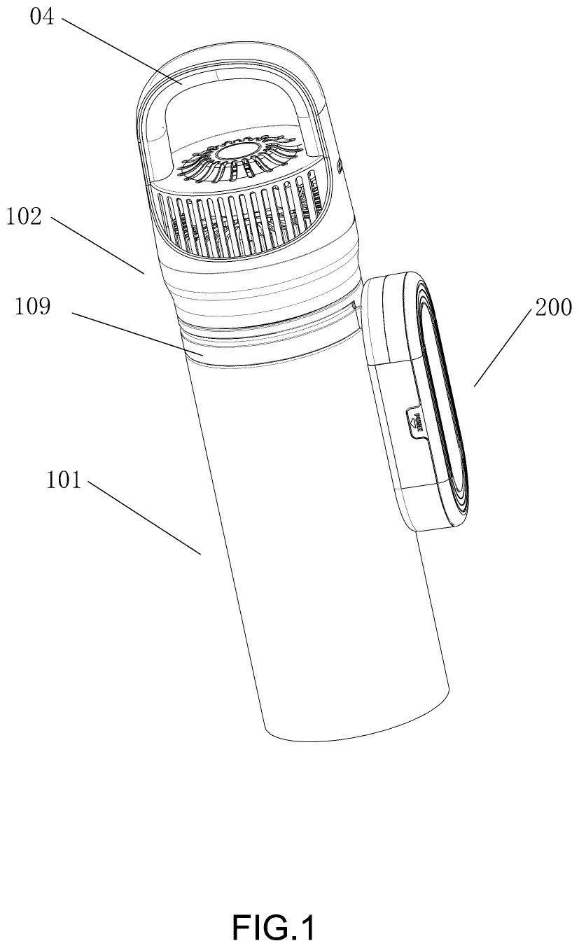

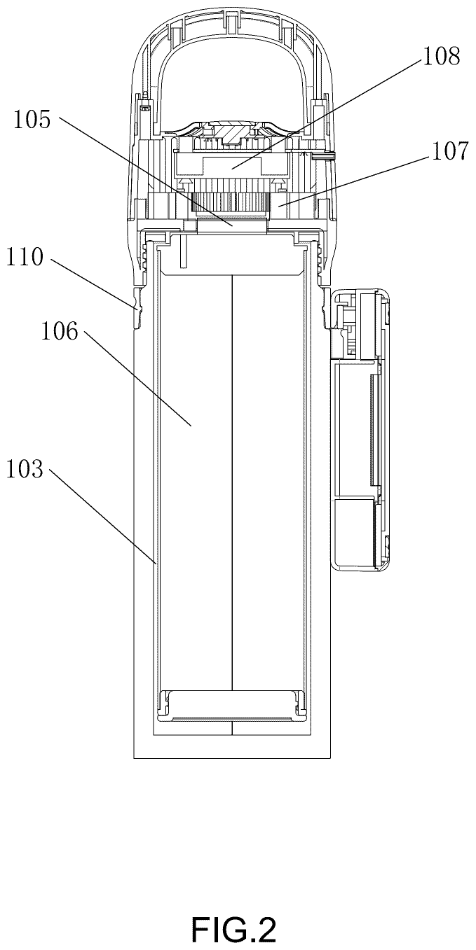

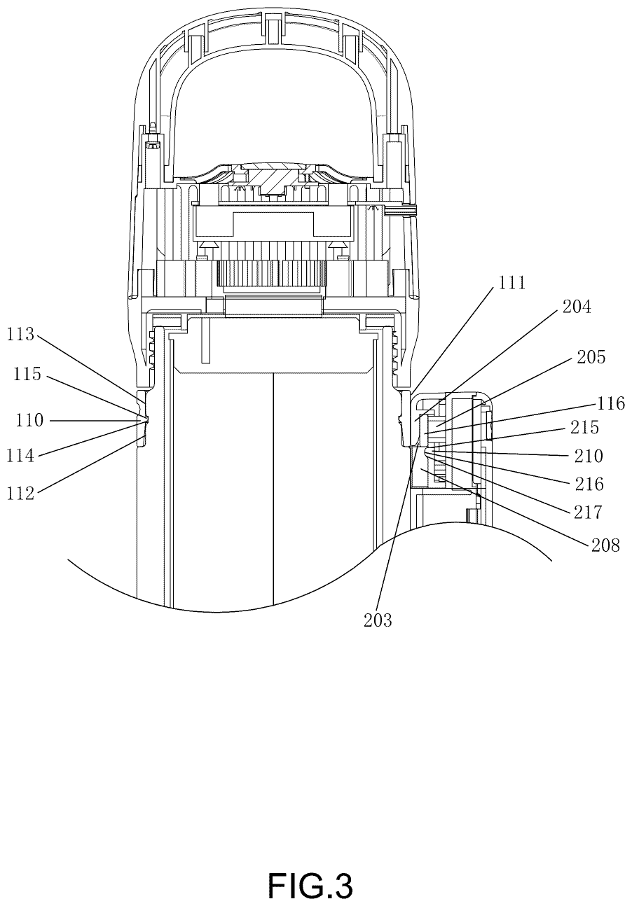

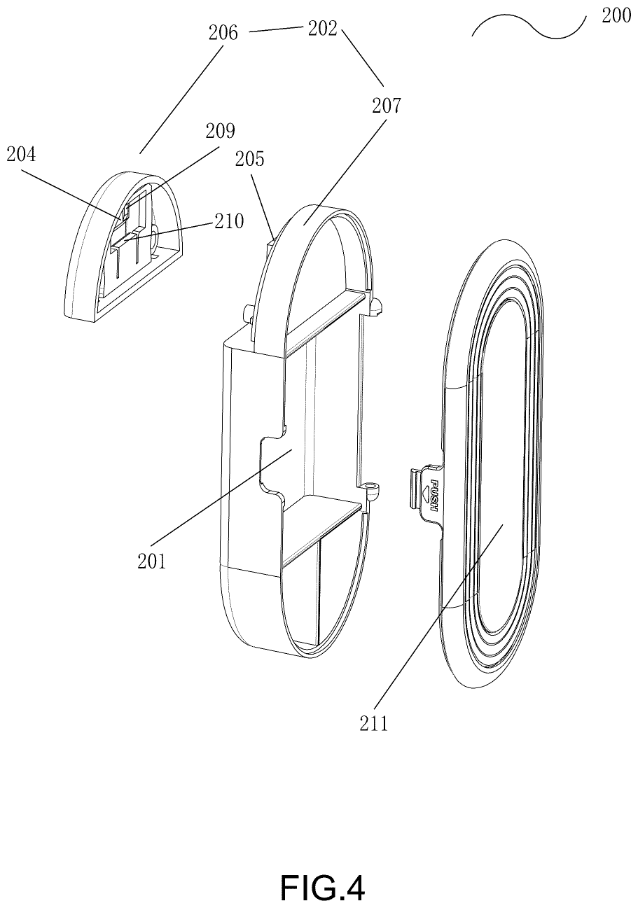

As shown in FIGS. 1-4, a medicine refrigeration cup with a portable medicine box includes a cup body, a refrigeration device, a hanging ring 109, and a medicine box 200. The cup body includes a cup main body 101 with a first medicine compartment 103 and a cup cover 102 configured to close the first medicine compartment 103. The cup cover 102 is provided with a handle 104 for gripping. The refrigeration device includes a semiconductor refrigeration chip 105 with a cold end face and a hot end face, a cold conduction tube 106 configured to connect the cold end face, a heat conduction member 107 configured to connect the hot end face, and a heat dissipation fan 108 provided above the heat conduction member 107. The cold conduction tube 106 is configured to be extended into the first medicine compartment 103 to create a low-temperature environment.

In this embodiment, the cup main body 101 includes a first disassembly-and-assembly part, which is a first hanging groove 111. The medicine box 200 includes a second medicine compartment 201 and an end portion 202 provided at one axial end of the second medicine compartment 201. The end portion 202 includes a second disassembly-and-assembly part, which is a second hanging groove 203. The hanging ring 109 includes a ring-shaped member 110 sleeved on the cup main body 101 and the first hanging groove 111 protruding from one side of the ring-shaped member 110. The first hanging groove 111 is arranged along an axial direction of the ring-shaped member 110 and includes a first outer groove wall 116. In an implementation mode, one end of the cup main body 101 close to the cup cover 102 is provided with an embedded area configured to install the hanging ring 109. The embedded area includes a circumferential step 112 configured to support the ring-shaped member 110 and a fitting circumferential wall 113 that is closely adhered to the ring-shaped member 110. The cup cover 102 and the circumferential step 112 are cooperated to form an axial limit on the ring-shaped member 110. The fitting circumferential wall 113 is radially inwardly concave to form an annular positioning groove 114, and a middle area of an inner circumferential wall of the ring-shaped member 110 is provided with a positioning rib 115 configured for the positioning groove 114 to be clamped into. The second hanging groove 203 includes an open end, a closed end, and a second outer groove wall 204. The second outer groove wall 204 is inserted into the first hanging groove 111, and the first outer groove wall 116 is configured to be inserted into the second hanging groove 203 through the open end and abut against the closed end. An upper end of the first outer groove wall 116 is configured to support the closed end along a gravity direction. Thus, the medicine box 200 is detachably suspended on the hanging ring 109.

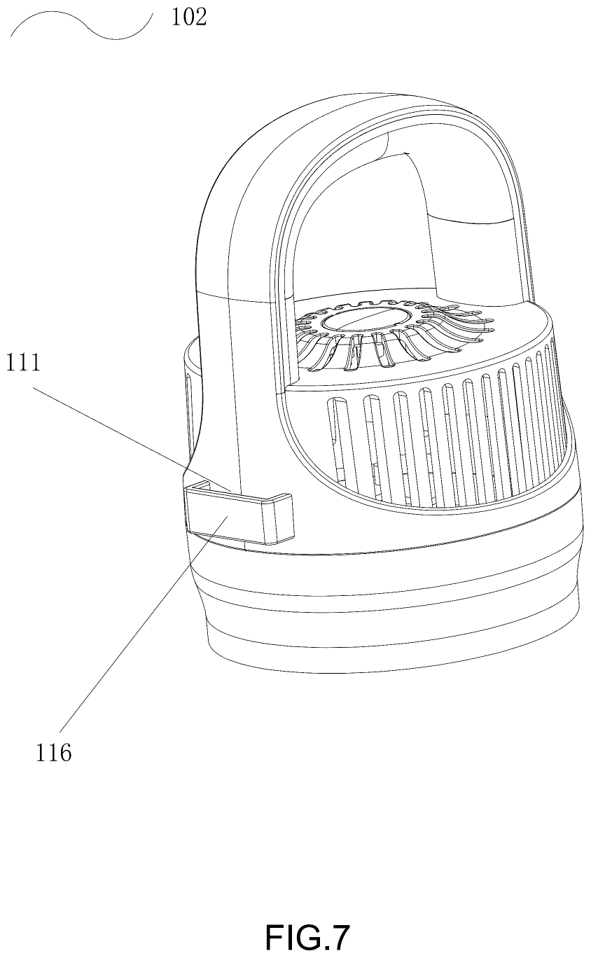

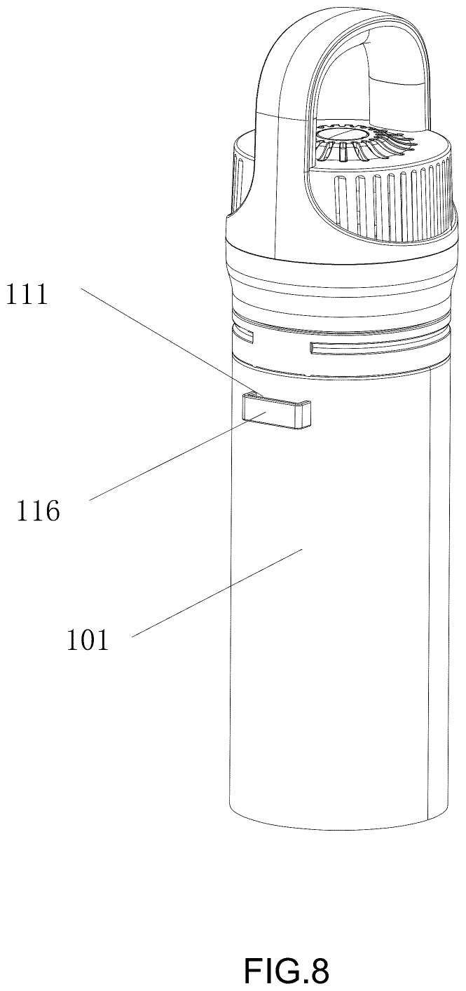

In some other embodiments, as shown in FIGS. 7 and 8, the first hanging groove 111 can be integrally formed on the cup cover 12 or the cup main body 101. It can be understood arrangement position and way of the first hanging groove 111, which is integrally formed or detachable through the hanging ring 109, and should not constitute a limitation on this.

In some other embodiments, the first hanging groove 111 includes the open end for the second outer groove wall 204 to be inserted into the first hanging groove 111 and the closed end configured to support the medicine box 200 along the gravity direction. It can be understood that the arrangement of the open end in the first hanging groove 111 and/or the second hanging groove 203 should not constitute a limitation on this.

In this embodiment, the end portion 202 includes a first end shell 206 and a second end shell 207 that are spliced together. The first end shell 206 includes the second outer groove wall 204 and an inlet chamber 208 configured to communicate with the open end. The first outer groove wall 116 is configured to translate into the inlet chamber 208. The second end shell 207 includes a second inner groove wall 205 configured to cooperate with the second outer groove wall 204 to form the second hanging groove 203, and the second outer groove wall 204 includes a plurality of limit protrusions 209, the limit protrusions 209 are cooperated with the second inner groove wall 205 to clamp the first outer groove wall 116. A limit tongue 210 configured to cover a part of the open end is provided in the inlet chamber 208. The first outer groove wall 116 is configured to overcome a resistance provided by the limit tongue 210 to enter and exit the second hanging groove 203. The second end shell 207 further includes a space configured to allow the limit tongue 210 to deform under pressure.

In an implementation mode, the limit tongue 210 includes a first limit inclined surface 215, a guide surface 216, and a second limit inclined surface 217. The first outer groove wall 116 is configured to overcome a resistance provided by the first limit inclined surface 215 to enter the second hanging groove 203, and the second groove wall is configured to overcome a resistance provided by the second limit inclined surface 217 to exit the second hanging groove 203. The guide surface 216 is arranged vertically and is configured to slide and cooperate with the first outer groove wall 116.

In this embodiment, one side of the second end shell 207 facing away from the first end shell 206 is provided with a unit medicine compartment configured to form a part of the second medicine compartment 201. The medicine box 200 further includes a cover plate 211 configured to seal the second medicine compartment 201. One side of the cover plate 211 is hinged to the second medicine compartment 201, and the other side of the cover plate 211 is interlocked with the second medicine compartment 201.

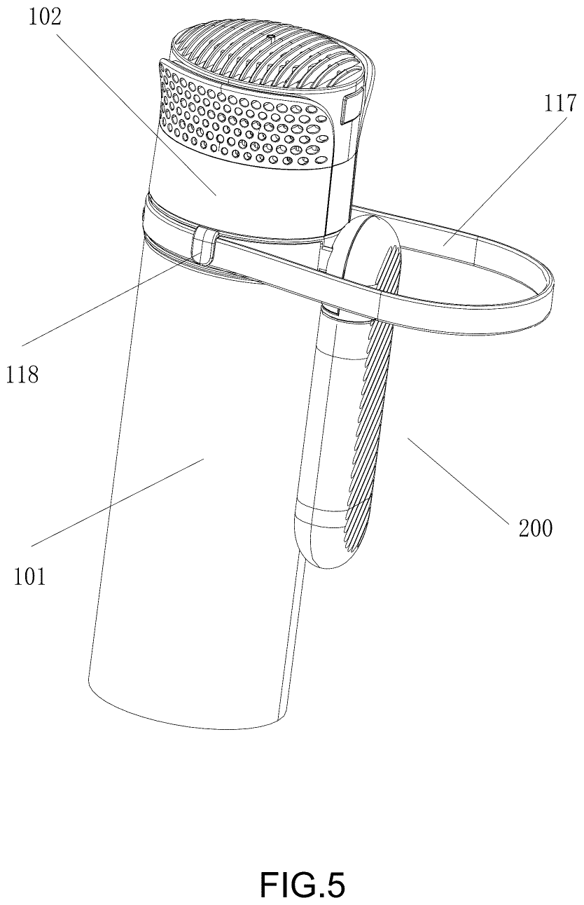

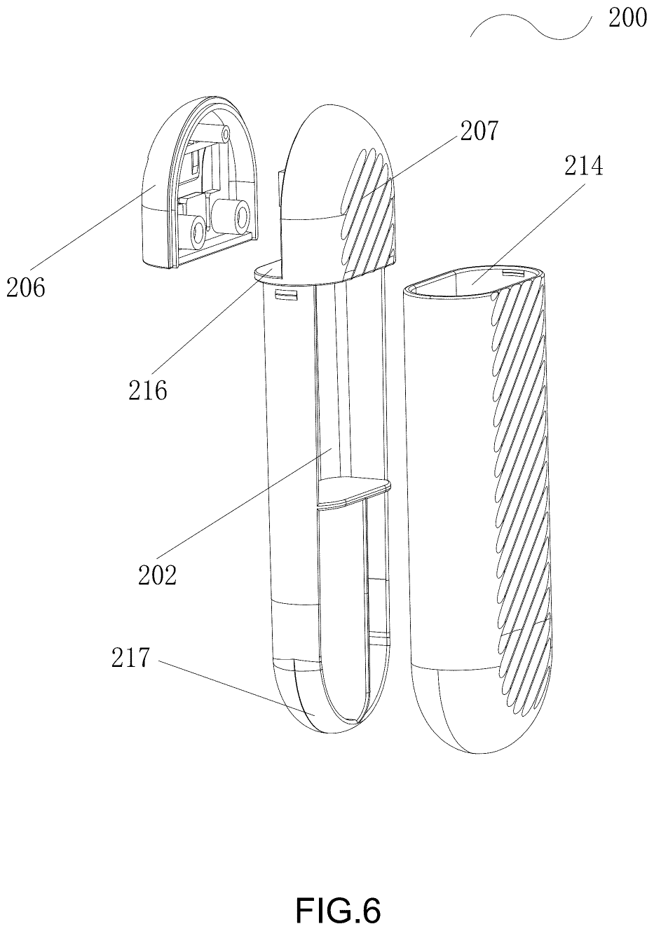

As shown in FIGS. 5-6, in an implementation mode, in the medicine refrigeration cup with a portable medicine box, one axial end of the second medicine compartment 201 shares a first stop end face 212 with the end portion 202, and a second stop end face 213 is provided at the other axial end of the second medicine compartment 201. The medicine box 200 includes an outer housing 214 configured to enclose the second medicine compartment 201, the outer housing 214 is suitable for ensuring a drying effect in the second medicine compartment 201, thereby avoiding an occurrence of moisture in the medicine stored in the medicine box 200. The outer housing 214 includes a cavity with a cavity opening. The second medicine compartment 201 enters the cavity through the cavity opening. When the second medicine compartment 201 is completely accommodated in the cavity, the cavity opening is interlocked with the second medicine compartment 201, and an outer surface of the end portion 202 is arranged flush with an outer surface of the outer housing 214. The two axial ends of the outer housing 214 are configured to respectively abut against the first stop end face 212 and the second stop end face 213.

In this embodiment, a user can lift or hold the cup body through an annular lift rope 117, and an outer circumferential surface of the ring-shaped member 110 is provided with a third hanging grooves 118. The annular lift rope 117 is configured to be inserted from an installation port provided below the third hanging groove 118.

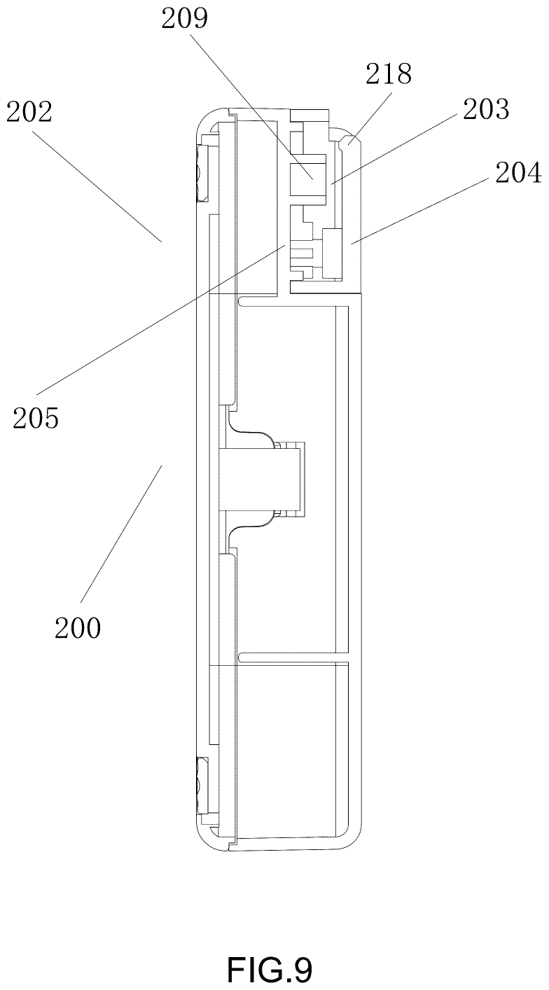

As shown in FIG. 9, in an implementation mode, in the medicine refrigeration cup with a portable medicine box, the open end is located at an upper end of the second hanging groove 203, and one end of the second outer groove wall 204 participates in enclosing to form the open end, and is internally fastened to form a stop tongue 218. The first outer groove wall 116 can be directly aligned with the open end and inserted into the second hanging groove 203, and an upper end of the first outer groove wall 116 is configured to support the stop tongue 218 along the gravity direction. In an implementation mode, the second inner groove wall 205 includes a plurality of limit protrusions 209, and the limit protrusions 209 cooperate with the second outer groove wall 204 to clamp the first outer groove wall 116.

In some other implementation modes, the first hanging groove 111 is arranged along a tangential direction of the ring-shaped member 110, the open end is located on a left side or a right side of the second hanging groove 203. The first hanging groove 111 is configured to support the second outer groove wall 204 in the gravity direction. It can be understood that a direction of plug-in fit between the first disassembly-and-assembly part and the second disassembly-and-assembly part should not constitute a limitation on this.

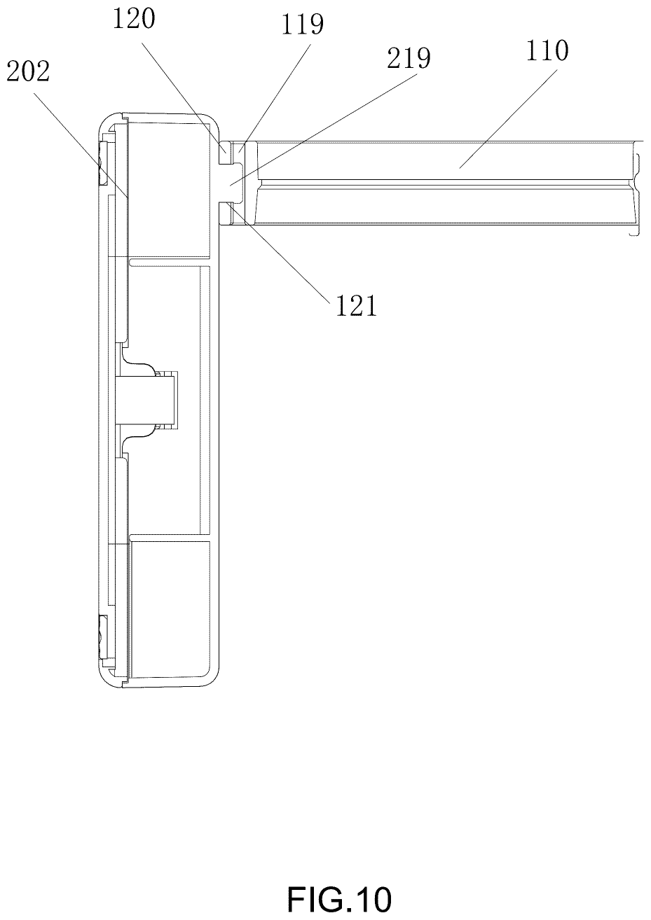

As shown in FIG. 10, in an implementation mode, in the medicine refrigeration cup with a portable medicine box, the hanging ring 109 includes the ring-shaped member 110 sleeved on the cup main body 101 and the first disassembly-and-assembly part protruding from one side of the ring-shaped member 110. The first disassembly-and-assembly part includes a fastening groove 119, and the medicine box 200 includes the second medicine compartment 201 and the end portion 202 provided at one axial end of the second medicine compartment 201. The end portion 202 includes the second disassembly-and-assembly part, and the second disassembly-and-assembly part includes a limit buckle 219 protruding from the end portion 202. The fastening groove 119 includes a limit groove wall 120 with a buttonhole 121. The limit buckle 219 is extended into the fastening groove 119 through the buttonhole 121, and the limit buckle 219 abuts against the limit groove wall 120 to limit a separation between the two.

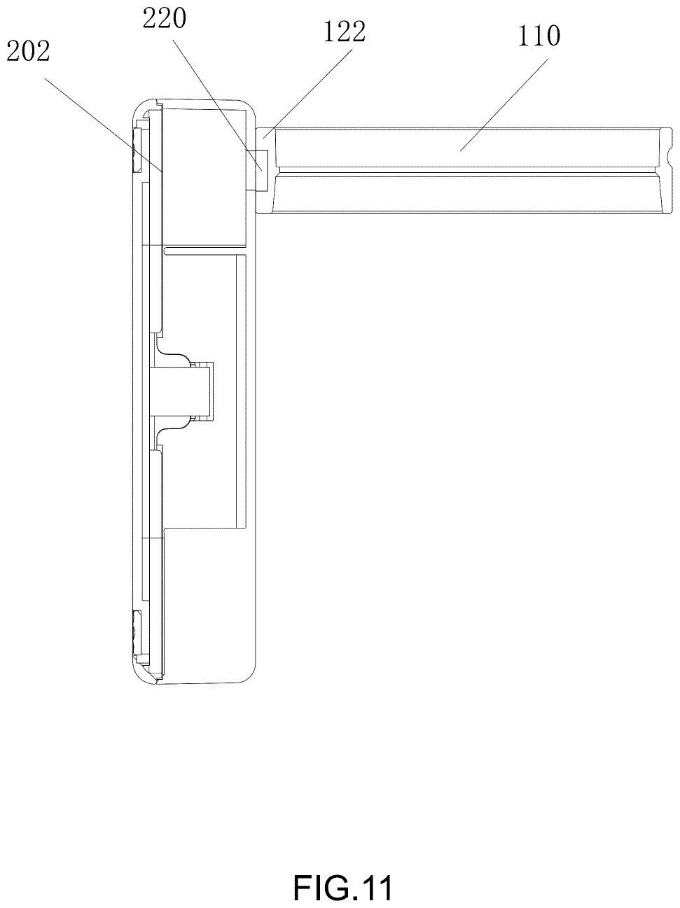

In some other implementation modes, as shown in FIG. 11, the first disassembly-and-assembly part includes a first magnetic suction member 122, and the second disassembly-and-assembly part includes a second magnetic suction member 220 protruding from the end portion 202. The first magnetic suction member 122 and the second magnetic suction member 220 are adsorbed and matched to achieve a suspension of the medicine box 200.

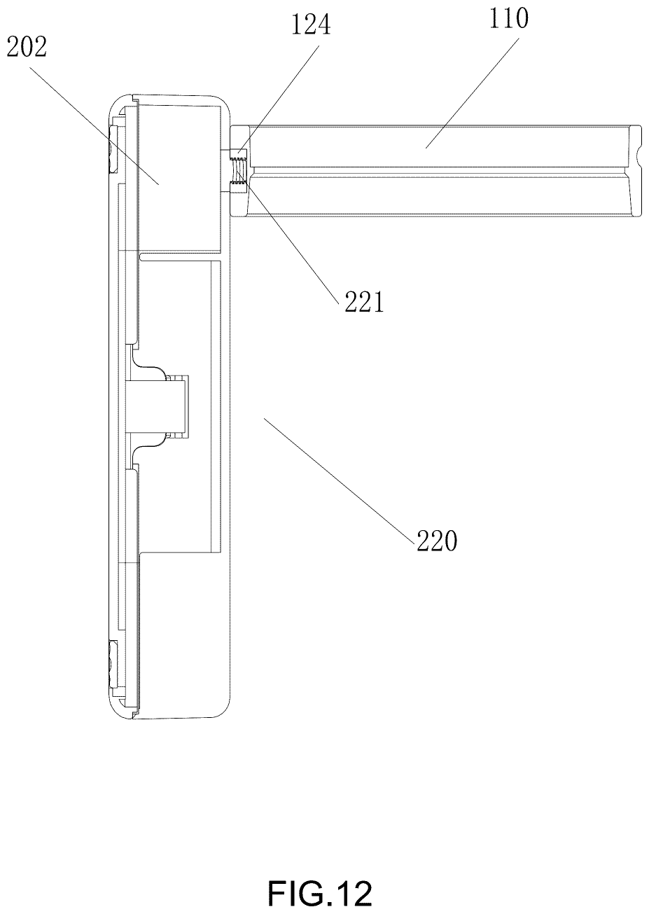

In other embodiments, as shown in FIG. 12, the first disassembly-and-assembly part includes an internal threaded structure 124, and the second disassembly-and-assembly part includes an external threaded structure 221 protruding from the end portion 202. The internal threaded structure 124 and the external threaded structure 221 are threaded together to achieve the suspension of the medicine box 200.

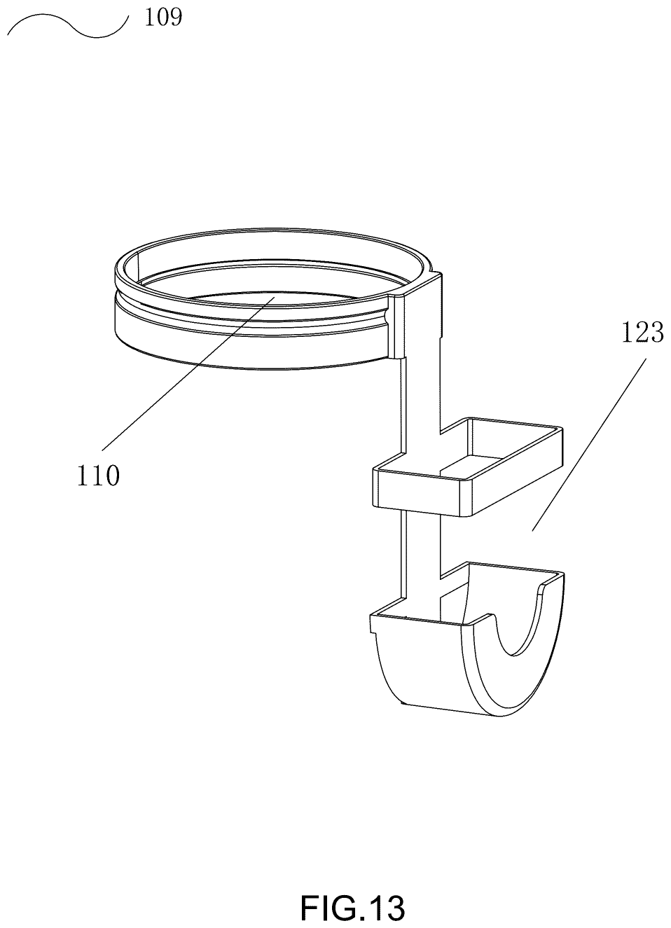

As shown in FIG. 13, in an implementation mode, in the medicine refrigeration cup with a portable medicine box, the hanging ring 109 includes the ring-shaped member 110 that is sleeved on the cup main body 101 and a mesh pocket part 123 protruding from one side of the ring-shaped member 110. The medicine box 200 can be inserted inro and removed from the mesh pocket part 123 to achieve the suspension of the medicine box 200. In an implementation mode, a depth of the mesh pocket part 123 exceeds one-third of a length of the medicine box 200.

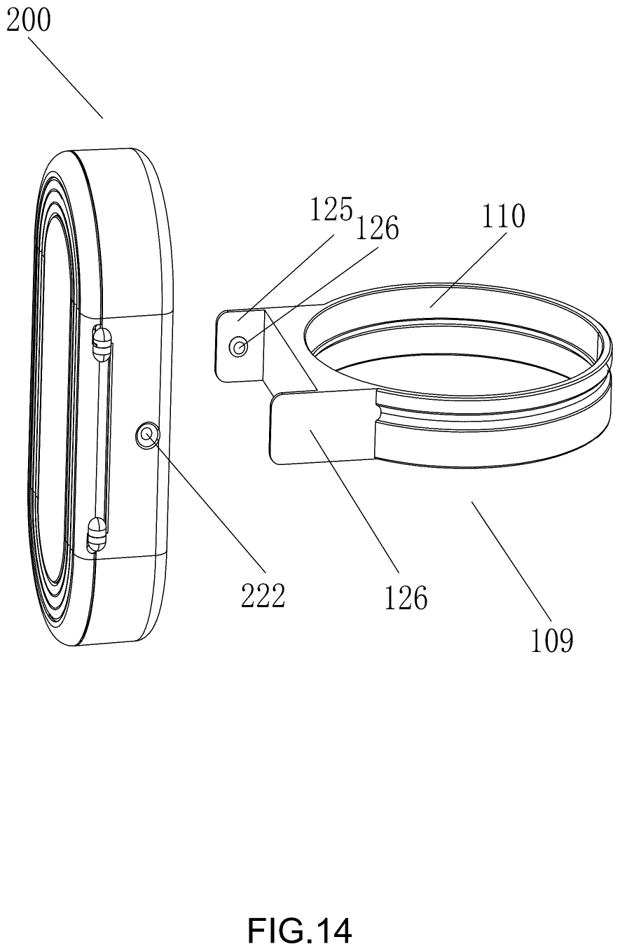

As shown in FIG. 14, in an implementation mode, in the medicine refrigeration cup with a portable medicine box, the first disassembly-and-assembly part includes two clamp walls 125 configured to clamp both sides of the medicine box 200, and the clamp walls 125 include an installation column 126 that is protruding arranged. The second disassembly-and-assembly part includes installation grooves 222 provided on two sides of the medicine box 200, and the installation column 126 is configured to be inserted into the installation grooves 222 to achieve the suspension of the medicine box 200.

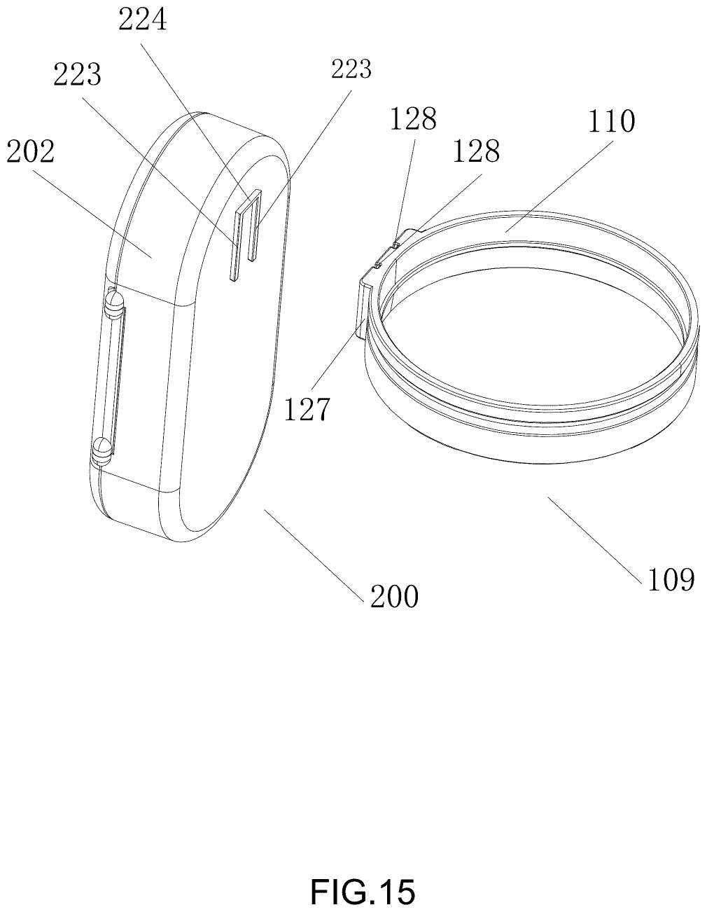

As shown in FIG. 15, in an implementation mode, in the medicine refrigeration cup with a portable medicine box, the first disassembly-and-assembly part includes a sliding seat 127 with two parallelly arranged sliding grooves 128, and the second disassembly-and-assembly part includes two parallelly arranged slid rails 223 that are protruding from the end portion 202, and a stop rail 224 configured to connect top ends of the two slid rails 223. The slid rails 223 and the sliding grooves 128 can slide and fit together in a pull-out manner, and a top end of the sliding seat 127 is configured to support the stop rail 224 in the gravity direction to achieve the suspension of the medicine box 200.

The above embodiments are only used to illustrate the technical solution of the present disclosure and not to limit it. Although the present disclosure has been described in detail with reference to the preferred embodiments, those skilled in the art should understand that the technical solution of the present disclosure can be modified or equivalently replaced without departing from the spirit and scope of the technical solution of the present disclosure.

What is claimed is:

1. A medicine refrigeration cup with a portable medicine box, comprising:
a cup body comprising a cup main body with a first medicine compartment and a cup cover configured to close the first medicine compartment,
a refrigeration device provided on the cup cover and configured to create a low-temperature environment in the first medicine compartment,
a medicine box detachably suspended from the cup main body or the cup cover,
wherein the cup main body or the cup cover comprises a first disassembly-and-assembly part, the medicine box comprises a second medicine compartment and an end portion provided at one axial end of the second medicine compartment; the medicine box comprises a second disassembly-and-assembly part,
a suspension of the medicine box is achieved by a plug-in fit, a snap fit, a thread fit, a magnetic suction fit, a snap fit, a clamp groove fit or a slide fit of the first disassembly-and-assembly part and the second disassembly-and-assembly part; or
the cup main body or the cup cover is connected to a mesh pocket part, and the medicine box is accommodated in the mesh pocket part to achieve the suspension of the medicine box.

2. The medicine refrigeration cup with a portable medicine box according to claim 1, wherein the first disassembly-and-assembly part comprises a first hanging groove, and the first hanging groove comprises a first outer groove wall,
the second disassembly-and-assembly part comprises a second hanging groove, and the second hanging groove comprises an open end, a closed end, and a second outer groove wall,
the second outer groove wall is inserted into the first hanging groove, and the first outer groove wall is configured to inserted into the second hanging groove through the open end and abut against the closed end,
the first hanging groove is configured to support the medicine box along a gravity direction, so that the medicine box is detachably suspended on the cup body.

3. The medicine refrigeration cup with a portable medicine box according to claim 1, wherein the first disassembly-and-assembly part comprises a fastening groove, the second disassembly-and-assembly part comprises a limit buckle protruding from the end portion,
the fastening groove comprises a limit groove wall with a buttonhole, the limit buckle is extended into the fastening groove through the buttonhole, and the limit buckle abuts against the limit groove wall to limit a separation between the two.

4. The medicine refrigeration cup with a portable medicine box according to claim 2, wherein the first hanging groove is arranged along the gravity direction, and the open end is located at a lower end of the second hanging groove; an upper end of the first outer groove wall is configured to support the closed end along the gravity direction, or
the open end is located at an upper end of the second hanging groove;
one end of the second outer groove wall forms the open end, and is internally fastened to form a stop tongue;
an upper end of the first outer groove wall is configured to support the stop tongue along the gravity direction; or
the first hanging groove is arranged along a tangent direction of the cup body, and the first hanging groove is configured to support the second outer groove wall along the gravity direction.

5. The medicine refrigeration cup with a portable medicine box according to claim 4, wherein the end portion comprises an inlet chamber configured to communicate with the open end,
wherein a limit tongue configured to cover a portion of the open end is provided in the inlet chamber,
the first outer groove wall is configured to translate into the inlet chamber, and the first outer groove wall is configured to overcome a resistance provided by the limit tongue to enter and exit the second hanging groove.

6. The medicine refrigeration cup with a portable medicine box according to claim 5, wherein the end portion comprises a first end shell and a second end shell that are spliced together,
the first end shell comprises the second outer groove wall and the limit tongue,
the second end shell comprises a second inner groove wall configured to cooperate with the second outer groove wall to form the second hanging groove, and a space configured to allow the limit tongue to deform under pressure.

7. The medicine refrigeration cup with a portable medicine box according to claim 6, wherein the second outer groove wall comprises a plurality of limit protrusions, and the limit protrusions cooperate with the second inner groove wall to clamp the first outer groove wall, or
the second inner groove wall comprises a plurality of limit protrusions, and the limit protrusions cooperate with the second outer groove wall to clamp the first outer groove wall.

8. The medicine refrigeration cup with a portable medicine box according to claim 1, further comprising a hanging ring,
wherein the hanging ring comprises a ring-shaped member sleeved on the cup main body and the second disassembly-and-assembly part protruding from one side of the ring-shaped member, or
the hanging ring comprises the ring-shaped member sleeved on the cup main body and the mesh pocket part protruding from one side of the ring-shaped member;
a depth of the mesh pocket part exceeds one-third of a length of the medicine box.

9. The medicine refrigeration cup with a portable medicine box according to claim 8, wherein an embedded area configured to install the hanging ring is formed at one end of the cup main body close to the cup cover,
wherein the embedded area comprises a circumferential step configured to support the ring-shaped member;
the cup cover cooperates with the circumferential step to form an axial limit on the ring-shaped member.

10. The medicine refrigeration cup with a portable medicine box according to claim 9, wherein the cup cover is provided with a handle that is capable of being held, and/or
an outer circumferential surface of the ring-shaped member is provided with a plurality of third hanging grooves configured to install an annular lift rope,
wherein the third hanging grooves comprise an installation port configured for the annular lift rope to be clamped into.

11. The medicine refrigeration cup with a portable medicine box according to claim 5, wherein the limit tongue comprises a first limit inclined surface, a guide surface, and a second limit inclined surface,
the first outer groove wall is configured to overcome a resistance provided by the first limit inclined surface to enter the second hanging groove, and the second groove wall is configured to overcome a resistance provided by the second limit inclined surface to exit the second hanging groove;
the guide surface is arranged in a vertical direction and is configured to slide and cooperate with the first outer groove wall.

12. The medicine refrigeration cup with a portable medicine box according to claim 9, wherein the embedded area further comprises a fitting circumferential wall that is closely adhered to the ring-shaped member, the fitting circumferential wall is radially inwardly concave to form an annular positioning groove, and a middle area of an inner circumferential wall of the ring-shaped member is provided with a positioning rib configured to be clamped into the positioning groove.

13. The medicine refrigeration cup with a portable medicine box according to claim 1, wherein the medicine box further comprises an outer housing configured to enclose the second medicine compartment,
the outer housing comprises a cavity with a cavity opening,
the second medicine compartment enters the cavity through the cavity opening, and when the second medicine compartment is completely accommodated in the cavity, the cavity opening is engaged with the second medicine compartment by interlocking or magnetic adsorption.

14. The medicine refrigeration cup with a portable medicine box according to claim 6, wherein the medicine box further comprises a cover plate configured to seal the second medicine compartment,
one side of the cover plate is hinged to the second medicine compartment, and the other side of the cover plate is engaged with the second medicine compartment by interlocking or magnetic adsorption.

15. The medicine refrigeration cup with a portable medicine box according to claim 14, wherein one side of the second end shell facing away from the first end shell forms a unit medicine compartment configured to form a part of the second medicine compartment, and the cover plate is configured to seal the unit medicine compartment.

16. The medicine refrigeration cup with a portable medicine box according to claim 13, wherein an outer surface of the end portion is arranged flush with an outer surface of the outer housing;
one axial end of the second medicine compartment shares a first stop end face with the end portion, and the other axial end of the second medicine compartment is provided with a second stop end face;
the two axial ends of the outer housing are configured to respectively abut against the first stop end face and the second stop end face.

17. The medicine refrigeration cup with a portable medicine box according to claim 1, wherein the refrigeration device comprises a semiconductor refrigeration chip with a cold end face and a hot end face, a cold conduction tube configured to connect the cold end face, a heat conduction member configured to connect the hot end face, and a heat dissipation fan provided above the heat conduction member;
wherein the cold conduction tube is configured to be extended into the first medicine compartment.
